(19) United States
(12) Patent Application Publication
(10) Pub. No.: US 2008/0123239 A1
(43) Pub. Date: May 29, 2008

(54) TRANSIENT VOLTAGE SURGE SUPPRESSOR

(75) Inventor: Glenn E. WILSON, Endicott, NY (US)

Correspondence Address: LOCKE LORD BISSELL & LIDDELL LLP;ATTN: IP DOCKETING, 600 TRAVIS STREET, 3400 CHASE TOWER, HOUSTON, TX, 77002, US

(73) Assignee: EMERSON ELECTRIC CO., St. Louis, MO (US)

(21) Appl. No.: 11/943,038

(22) Filed: Nov. 20, 2007

Related U.S. Application Data
(60) Provisional application No. 60/867,523, filed on Nov. 28, 2006.

(51) Int. Cl. H02H 3/22

(52) U.S. Cl. 361/111

(57) ABSTRACT

A transient voltage surge suppressor (TVSS) system includes a gas tube connected in series with a clamping component between a first terminal and a second terminal. A voltage sense circuit is connected between the first and second terminals. The voltage sense circuit triggers the gas tube to conduct in response to a predetermined condition between the first and second terminals.

### CROSS REFERENCE TO RELATED APPLICATIONS

This application claims the benefit of U.S. Provisional Application No. 60/867,523 filed Nov. 28, 2006.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO APPENDIX

Not applicable.

### BACKGROUND

1. Field of the Invention

The present invention relates generally to an improved transient voltage surge suppressor (TVSS).

2. Description of Related Art

Various electrical components are used to suppress high voltage transients, which would otherwise cause significant damage to various electrical and electronic devices. An effective surge suppression component is characterized by a very high resistance (impedance) under normal circuit operating voltages and a very low resistance (impedance) in response to higher transient voltages. Among such components are metal oxide varistors (MOVs), thermistors, selenium rectifiers, gas tubes and others.

These components each have a rough “activation voltage range”—the approximate voltage at which the components makes the transition from high impedance to low impedance. If the activation voltage is too low, the device will conduct under normal operating conditions, resulting in undesirable energy drain and in heating of the component that could lead to premature failure. Conversely, if the activation voltage is too high, potentially damaging transient voltages will not be safely clamped to non-damaging voltages. Ideally, the activation voltage would be a known, exact voltage. However, this has been unattainable with known “real world” components.

To address this problem, the prior art has produced various precision clamping circuits that include semiconductor switches and resistive and capacitive loads. However, each of the solutions proposed to date has been relatively complex and expensive, and has still failed to provide the desired precision of operation coupled simultaneously with high clamping current capability and low cost.

The present application addresses shortcomings associated with the prior art.

### BRIEF SUMMARY

Among other things, a high precision TVSS circuit is disclosed that uses non-ideal surge suppression components (i.e., those with relatively wide activation voltage ranges) and is simple in construction and inexpensive, yet it still has a very precisely controlled activation voltage. In accordance with certain aspects of the present disclosure, a TVSS system includes a gas tube connected in series with a clamping component between a first terminal and a second terminal. A voltage sense circuit is connected between the first and second terminals. The voltage sense circuit triggers the gas tube to conduct in response to a predetermined condition between the first and second terminals.

In certain implementations, the predetermined condition is a voltage larger than a predetermined value between the first and second terminals. In other embodiments, the predetermined condition is an increase in voltage faster than a predetermined rate between the first and second terminals. A trigger coil connected to the gas tube, wherein the trigger coil generates a high voltage field in response to the voltage sense circuit to trigger the gas tube.

The disclosure provides a transient voltage surge suppression (TVSS) system, comprising: a clamping component; a gas tube connected in series with the clamping component between a first terminal and a second terminal; and a voltage sense circuit connected between the first and second terminals, the voltage sense circuit triggering the gas tube to conduct in response to a predetermined condition between the first and second terminals.

The disclosure also provides a method of suppressing voltage transients, comprising: monitoring a voltage between a first terminal and a second terminal; activating a trigger coil connected to a gas tube to ionize gas in the gas tube and allow current to flow through the tube in response to the monitored voltage.

### BRIEF DESCRIPTION OF THE DRAWINGS

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art as required by 35 U.S.C. §112.

FIG. 1 is a high level schematic diagram of a transient voltage surge suppressor (TVSS) circuit in accordance with certain teachings of the present disclosure.

FIG. 2 is a schematic diagram of an exemplary embodiment of the precision voltage sense circuit shown in FIG. 1.

FIG. 3 is a schematic diagram of another exemplary embodiment of the precision voltage sense circuit shown in FIG. 1.

FIG. 4 is a schematic diagram of an exemplary circuit to allow a multiplicity of bi-directional inputs.

### DETAILED DESCRIPTION

One or more illustrative embodiments incorporating the invention disclosed herein are presented below. Not all features of an actual implementation are described or shown in this application for the sake of clarity. It is understood that the development of an actual embodiment incorporating the present invention, numerous implementation-specific decisions must be made to achieve the developer's goals, such as compliance with system-related, business-related, and other constraints, which vary by implementation and from time to time. While a developer's efforts might be complex and time-consuming, such efforts would be, nevertheless, a routine undertaking for those of ordinary skill in the art having benefit of this disclosure.

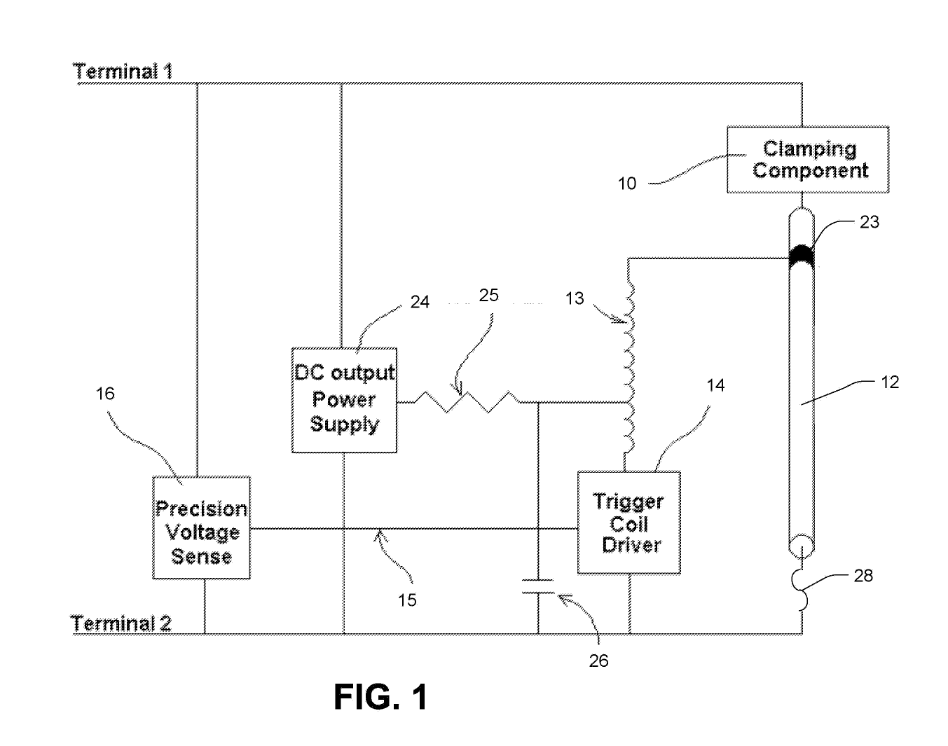

FIG. 1 is a high level schematic diagram of a transient voltage surge suppressor (TVSS) circuit in accordance with certain teachings of the present disclosure. Terminal 1 and terminal 2 are the connection points at which the disclosed TVSS circuit may be connected to a circuit to be protected from transient overvoltage conditions. A clamping component 10 and a gas tube 12 are series connected between terminal 1 and terminal 2. The clamping component 10 may be any component with a linear or non-linear voltage/current profile. A linear component, for example, may be as simple as a resistor whose value may be as low as near zero ohms. Examples of a non-linear component include a zener diode, bi-directional zener diode, MOV, thermistor, selenium rectifier, silicon avalanche diode (SAD) or other non-linear component. A linear component such as a simple resistor works for the clamping component 10 because the gas tube 12 is generally non-conductive (i.e., has a very high impedance) during normal operating conditions, but will become conductive (i.e., will transition to a low impedance state) in response to a high voltage between terminal 1 and terminal 2. For reasons that will be apparent in light of the description below, the activation voltage of the clamping component 10 may be any value less than or approximately equal to the normal operating voltage between terminal 1 and terminal 2.

If a linear component, such as a resistor, is used for the clamping component 10, the cost of the circuit may be considerably decreased and thus, it may be possible to design circuits designed to handle higher currents in the same volume. A drawback of a using a linear component is the possible extra time it may take for the input voltage to drop far enough to lower the gas tube's 12 hold current and release the circuit from drawing current. A non-linear component used for the clamping component 10 typically costs more but will allow the gas tube's 12 hold current to drop sooner allowing the circuit to become high-impedance sooner.

The gas tube 12 may be any typical gas tube as known to those of ordinary skill in the art. In exemplary embodiments, the gas tube 12 contains argon and has a very wide breakdown voltage range, which may also be hundreds of volts higher than the normal operating voltage between terminal 1 and terminal 2. A suitable gas tube is a model SU-L400-S11N gas surge arrester available from NetCast International LTD, Hong Kong. A trigger coil 13 is connected to the gas tube 12 via a metal band 23 to ionize the gas within the gas tube 12, which will cause the gas in the gas tube 12 to become conductive. A trigger coil driver 14 is connected to the trigger coil 13, which is connected to a precision voltage sense circuit 16. The trigger coil driver 14 may be any circuit that, in response to a trigger voltage from the voltage sense circuit 16, will activate trigger coil 13 and thus output a pulse sufficiently high in voltage to ionize the gas in the gas tube 12. Typically this is a pulse of between 4,000 volts and 20,000 volts.

Under normal operating conditions, the series combination of the clamping component 10 and the gas tube 12 will be of sufficiently high impedance to prevent flow of current between terminals 1 and 2. In response to a high transient voltage appearing between terminals 1 and 2, the voltage at the output 15 of the precision voltage sense circuit 16 will increase sufficiently to trigger the coil driver 14. The coil driver 14 will then supply a voltage pulse to the trigger coil 13, resulting in the ionization of gas within the gas tube 12. The gas tube 12 will then become conducting, i.e. will exhibit a dramatic decrease in impedance. Because of the decreased impedance of the gas tube 12, the clamping component 10 will transition to its low impedance state and conduct current causing current to flow between terminal 1 and terminal 2. This current flow will serve as a clamp on the voltage between terminals 1 and 2, preventing an electrical device connected between the terminals from being damaged by the high transient current. A circuit breaker or fuse 28 may further be provided in series with the clamping component 10 and gas tube 12 to protect against catastrophic failure of either the clamping component 10 or the gas tube 12. Should the same transient have come along without a TVSS circuit across the lines, the transient would have been manifested as a high voltage between terminals 1 and 2.

The precision voltage sense circuit 16 may be any of various fast responding circuits that will trigger the coil driver circuit in response to a pre-determined condition between terminals 1 and 2, such as a high voltage transient. In one exemplary embodiment, the voltage sense circuit 16 may be constructed of a simple, and inexpensive, resistor voltage divider. Because these components are responsible for the high-precision operation of the circuit, these resistors are preferably 0.01% tolerance resistors. However, components of any arbitrary tolerance may be selected depending on the application. Because only the sense resistors are required to be of relatively high tolerance, the cost of the circuit is reduced over prior art circuits using high tolerance clamping devices. By careful selection of the values of the resistors in the voltage divider, the designer may design a circuit that will draw only picoamps of current at normal operating voltages, for example 615 VAC, yet will trigger the clamping circuit in response to “high” voltages as little as ¼ VAC higher than the operating voltage.

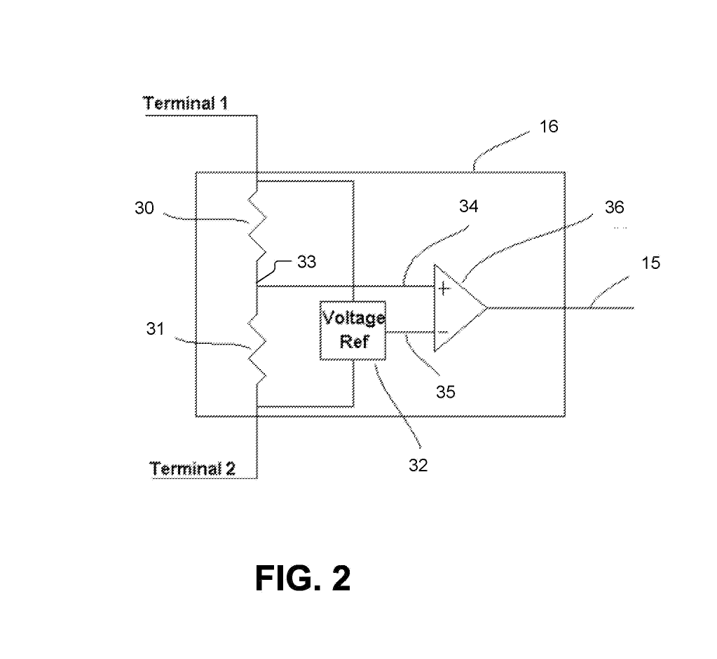

FIG. 2 illustrates one embodiment of the precision voltage sense circuit 16, which may be termed “fixed threshold sense.” This embodiment contains a resistor divider made up of a top resistor 30 and a bottom resistor 31. The top resistor 30 is typically high in resistance and may be 100,000 ohms or more. The value of the bottom resistor 31 is determined by the value of the top resistor and the value of the voltage reference used in conjunction with the required triggering voltage. The bottom resistor 31 may typically range from 3,000 ohms to 40,000 ohms. The divider voltage output at the junction 33 of the top and bottom resistors 30, 31 may be calculated by

$$Voltage 33 = \frac{( Terminal Voltage 1 - Terminal Voltage 2 ) * ( resistor 30 )}{( resistor 30 + resistor 31 )}$$

A comparator 36 has one input 34 connected to the output 33 of the voltage divider and another input 35 connected to a voltage reference 32. The voltage reference 32 may be powered as shown in FIG. 2 or from a secondary power supply. The output of the comparator 36 is the output 15 of the precision voltage sense circuit 16, which is received by the trigger coil driver 14. An example of a suitable reference 32 and comparator 36 is an Analog Devices model ADCMP350 comparator, which provides a voltage reference and comparator in a single device.

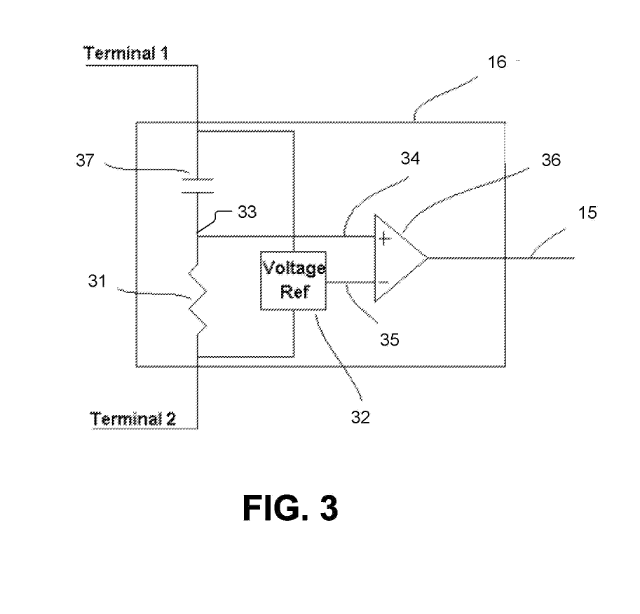

FIG. 3 is a schematic diagram of another exemplary embodiment of the precision voltage sense circuit 16 shown in FIG. 1 This precision voltage sense may be referred to as the “dV/dT sense,” since it is based on sensing the change in voltage with respect to change in time. The dV/dT sense circuit operates similar to the fixed threshold sense circuit discussed above. The dV/dT sense operates on the principle of detecting and acting upon rapid increases in voltage regardless of the actual voltage. If the entire circuit detects a rapid change of voltage when the actual voltage between terminal 1 and terminal 2 are low, no current will flow through the clamping component 10 and the gas tube 12, but no harm will be done. On the other hand, this method has advantages. The clamping component 10 and the gas tube 12 will be allowed to conduct at the earliest possible time, a major advantage in containing transient energy.

A capacitor 37 is connected to the resistor 31. The capacitor 37 has an impedance that varies with frequency and is known in the art to be described as Xc=1/(2*π*F*C) where “Xc” is the impedance of the capacitor at a given frequency, F is frequency in Hertz, and C is the value of the capacitor in farads. The goal of this method is to chose a value for C such that normal operating frequency such as 50 Hz or 60 Hz will not cause the circuit to trip, and yet if a rate of change of input voltage occurs, such as 2,000 Hz for example, the value of Xc will be much higher and thus trip the circuit. The capacitor 37 and resistor 31 work together such that, with slow changing input voltages such as 60 Hz, very little current will flow through the capacitor 37 into the resistor 31 and not be detected by the comparator 36. Rapidly changing input voltages with frequencies much greater than 60 Hz, however, will cause current to flow through the capacitor 37 and into the resistor 31, causing the voltage at the comparator input 34 to raise up far enough for the comparator 36 to activate the coil driver 14.

The connections to terminals 1 and 2 can vary widely depending on the particular application. For example, terminal 1 may be the line voltage of a single phase AC circuit, while terminal 2 is the ground terminal. In another application, terminal 1 may be connected to line voltage and terminal 2 may be connected to neutral. In a different application, terminal 1 may be connected to one phase voltage of a multi-phase system and terminal 2 connected to a different phase voltage of the same system. In further applications, terminal 1 may be connected to a positive voltage of a direct current circuit and terminal 2 may be connected to the neutral or negative voltage of that circuit. In the case of a DC circuit, a means for dropping the current below the hold current of the gas tube 12 must be provided so the clamping component 10 may be released after the incoming transient is gone.

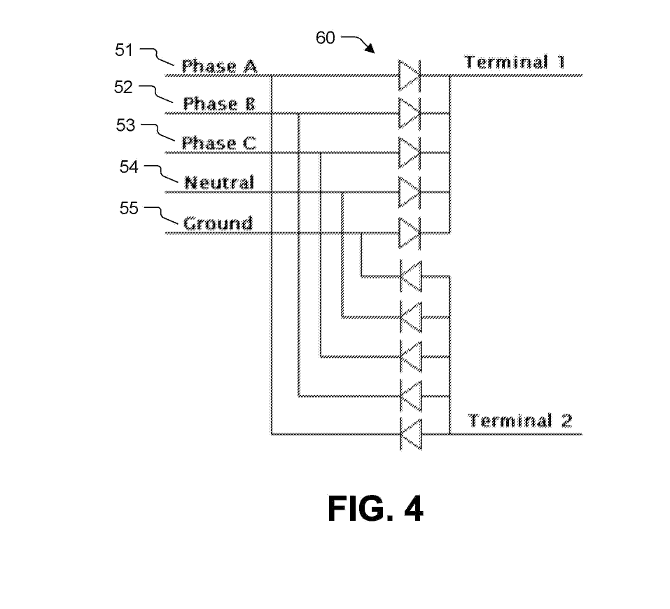

The circuits shown in FIGS. 1, 2, and 3 all illustrate unidirectional current flow, i.e. terminal 1 being greater than terminal 2. Other versions can be used in an AC circuit. One example is shown in FIG. 4, which also allows for a multiplicity of inputs.

FIG. 4 is a schematic diagram of an exemplary circuit to allow a multiplicity of bi-directional inputs. The circuit shown in FIG. 4 includes Phase A, B and C terminals 51, 52, 53 and neutral and ground terminals 54, 55 connected to terminals 1 and 2 via diodes 60.

The invention has been described in the context of preferred and other embodiments and not every embodiment of the invention has been described. Apparent modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intends to protect all such modifications and improvements to the full extent that such falls within the scope or range of equivalent of the following claims.

The various methods and embodiments of the invention can be included in combination with each other to produce variations of the disclosed methods and embodiments, as would be understood by those with ordinary skill in the art, given the understanding provided herein. Also, various aspects of the embodiments could be used in conjunction with each other to accomplish the understood goals of the invention. Also, the directions such as “top,” “bottom,” “left,” “right,” “upper,” “lower,” and other directions and orientations are described herein for clarity in reference to the figures and are not to be limiting of the actual device or system or use of the device or system. Unless the context requires otherwise, the word “comprise” or variations such as “comprises” or “comprising”, should be understood to imply the inclusion of at least the stated element or step or group of elements or steps or equivalents thereof, and not the exclusion of a greater numerical quantity or any other element or step or group of elements or steps or equivalents thereof The device or system may be used in a number of directions and orientations. Further, the order of steps can occur in a variety of sequences unless otherwise specifically limited. The various steps described herein can be combined with other steps, interlineated with the stated steps, and/or split into multiple steps. Additionally, the headings herein are for the convenience of the reader and are not intended to limit the scope of the invention.

Further, any references mentioned in the application for this patent as well as all references listed in the information disclosure originally filed with the application are hereby incorporated by reference in their entirety to the extent such may be deemed essential to support the enabling of the invention. However, to the extent statements might be considered inconsistent with the patenting of the invention, such statements are expressly not meant to be considered as made by the Applicant(s).

1. A transient voltage surge suppression (TVSS) system, comprising:
a clamping component;
a gas tube connected in series with the clamping component between a first terminal and a second terminal; and
a voltage sense circuit connected between the first and second terminals, the voltage sense circuit triggering the gas tube to conduct in response to a predetermined condition between the first and second terminals.

2. The TVSS system of claim 0, wherein the predetermined condition is a voltage larger than a predetermined value between the first and second terminals.

3. The TVSS system of claim 0, wherein the predetermined condition is an increase in voltage faster than a predetermined rate between the first and second terminals.

4. The TVSS system of claim 0, further comprising a trigger coil connected to the gas tube, wherein the trigger coil generates a high voltage field in response to the voltage sense circuit to trigger the gas tube.

5. The TVSS system of claim 4, wherein the voltage sense circuit includes a resistor voltage divider.

6. The TVSS system of claim 5, wherein the voltage sense circuit includes a comparator receiving an output of the resistor voltage divider and a reference voltage, wherein the gas tube is triggered in response to an output of the comparator.

7. The TVSS system of claim 4, wherein the voltage sense circuit includes a resistor and a capacitor connected in series between the first and second terminals.

8. The TVSS system of claim 7, wherein the voltage sense circuit includes a comparator having one input connected to the junction of the resistor and the capacitor and another input receiving a reference voltage, wherein the gas tube is triggered in response to an output of the comparator.

9. The TVSS system of claim 0, further comprising a fuse connected in series with the gas tube.

10. The TVSS system of claim 0, further comprising a circuit breaker connected in series with the gas tube.

11. The TVSS system of claim 0, wherein the gas tube contains argon.

12. The TVSS system of claim 0, wherein the TVSS system gas tube contains argon.

13. The TVSS system of claim 0, wherein the TVSS system is used in a DC circuit.

14. The TVSS system of claim 0, wherein the TVSS system is used in a AC circuit.

15. The TVSS system of claim 0, wherein the TVSS system includes a plurality of input terminals.

16. The TVSS system of claim 0, wherein the clamping component is a linear device.

17. The TVSS system of claim 16, wherein the linear device has an impedance of zero ohms.

18. The TVSS system of claim 16, wherein the linear device has an impedance of greater than zero ohms.

19. A method of suppressing voltage transients, comprising:
monitoring a voltage between a first terminal and a second terminal;
activating a trigger coil connected to a gas tube to ionize gas in the gas tube and allow current to flow through the tube in response to the monitored voltage.

20. The method of claim 19, wherein activating the trigger coil includes providing a voltage pulse to the trigger coil from a trigger coil driver.

21. The method of claim 20, wherein activating the trigger coil allows current to flow through a clamping component connected in series with the gas tube.

22. The method of claim 20, wherein activating the trigger coil includes activating the trigger coil in response to the voltage between the first and second terminals being larger than a predetermined value.

23. The method of claim 20, wherein activating the trigger coil includes activating the trigger coil in response to the voltage between the first and second terminals increasing faster than a predetermined rate.

24. The method of claim 20, wherein monitoring the voltage includes:
connecting a resistor voltage divider between the first and second terminals, and
comparing the output of the resistor voltage divider to a predetermined reference voltage.

25. The method of claim 20, wherein monitoring the voltage includes:
connecting a capacitor and a resistor in series between the first and second terminals, and
comparing a voltage at the junction of the capacitor and the resistor to a predetermined reference voltage.
